(19) United States
(12) Patent Application Publication
(10) Pub. No.: US 2007/0262922 A1
(43) Pub. Date: Nov. 15, 2007

(54) DRIVING A PLASMA DISPLAY PANEL

(75) Inventors: Choon Sub KIM, Hwasung-si (KR); Won Jae KIM, Masan-si (KR); Won Soon KIM, Gumi-si (KR); Sung Im LEE, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/747,288

(22) Filed: May 11, 2007

(30) Foreign Application Priority Data
May 12, 2006 (KR) 10-2006-0042970

(51) Int. Cl. G09G 3/28

(52) U.S. Cl. 345/60

(57) ABSTRACT

A plasma display apparatus and method of driving the plasma display apparatus are described. The method includes applying a first driving signal to a first scan electrode to effect at least one of a reset period and a sustain period, applying a second driving signal to a second scan electrode to effect at least one of a reset period and a sustain period, and controlling at least one of the first and second driving signals to cause a lag in an initiation of a changing voltage characteristic on the first scan electrode during at least one of the reset period and the sustain period relative to an initiation of a corresponding changing voltage characteristic on the second scan electrode.

This disclosure claims priority from Korean Patent Application No. 10-2006-0042970 filed on May 12, 2006 in the Korean Intellectual Property Office, the disclosure of which is incorporated herein by reference in its entirety.

### BACKGROUND

1. Field

This disclosure relates to driving a plasma display panel (PDP) in which a driving signal to be applied to scan electrodes is delayed, e.g., using scan integrated circuits (ICs) and delay units.

2. Description of the Related Art

Plasma display panels (PDPs) are flat panel devices which generate a perceivable display using plasma generated by a gas discharge. PDPs may include thousands of or even millions of pixels that are arranged in a matrix form. PDPs are classified into direct current (DC)-type PDPs and alternating current (AC)-type PDPs according to the type of a driving voltage applied thereto and the structure of discharge cells included therein.

DC-type PDPs have a structure in which electrodes are not insulated but exposed to a discharge space. Thus, in the case of DC-type PDPs, a current flows in the discharge space as long as a voltage is applied. On the other hand, AC-type PDPs have a structure in which electrodes are covered with a dielectric layer, and can thus generate capacitance naturally.

AC-type PDPs include scan electrode and sustain electrode lines which are formed in parallel on one surface of the AC-type PDP, and address electrodes which are formed on the other surface of the AC-type PDP and which intersect the scan electrodes and the sustain electrodes. The sustain electrodes respectively correspond to the scan electrodes. One end of each sustain electrode is connected to one end of each respective scan electrode.

In general, an AC-type PDP is driven in a time-division manner by dividing each sub-field into a reset period, an address period, a sustain period, and an erase period.

During the reset period, cells are initiated to enable addressing. During the address period, an address voltage is applied to cells to be addressed, enabling the cells to be addressed and to enable accumulation of wall charges in addressed cells. During the sustain period, a sustain discharge voltage is applied to the addressed cells, causing a sustain discharge and enabling an image to be displayed by the addressed cells. During the erase period, the wall charges are reduced in the addressed cells, causing the sustain discharge to dissipate and the image to erase.

Addressing in a PDP may be performed by scan integrated circuits (ICs) that are formed on a scan buffer board. The scan ICs respectively correspond to scan electrodes that are formed on the PDP. Therefore, the vertical length of the scan buffer board is generally the same as or less than the vertical length of the PDP.

### SUMMARY

A plasma display panel (PDP) is driven using a driving signal applied to a plurality of scan electrodes that is delayed using scan integrated circuits (ICs) and delay units.

In one general aspect, driving a plasma display apparatus includes applying a first driving signal to a first scan electrode to effect at least one of a reset period and a sustain period, applying a second driving signal to a second scan electrode to effect at least one of a reset period and a sustain period, and controlling at least one of the first and second driving signals to cause a lag in an initiation of a changing voltage characteristic on the first scan electrode during at least one of the reset period and the sustain period relative to an initiation of a corresponding changing voltage characteristic on the second scan electrode.

In another general aspect, driving a plasma display apparatus includes applying a first driving signal to a first scan electrode to effect at least one of a reset period and a sustain period, applying a second driving signal to a second scan electrode to effect at least one of a reset period and a sustain period, and controlling at least one of the first and second driving signals to cause a lag in a changing voltage characteristic on the first scan electrode during at least one of the reset period and the sustain period relative to a corresponding changing voltage characteristic on the second scan electrode.

In another general aspect, a plasma display panel includes an upper substrate, a lower substrate opposite to the upper substrate, scan electrodes positioned between the upper and lower substrates, address electrodes positioned between the upper and lower substrates, sustain electrodes positioned between the upper and lower substrates and a control circuit. The scan electrodes include first and second scan electrodes. The control circuit is configured to apply a first driving signal to the first scan electrode to effect at least one of a reset period and a sustain period and to apply a second driving signal to the second scan electrode to effect at least one of a reset period and a sustain period. The control circuit is configured to control the first and second driving signals to cause a lag in a changing voltage characteristic on the first scan electrode during at least one of the reset period and the sustain period relative to a corresponding changing voltage characteristic on the second scan electrode.

Implementations may include one or more of the following features. For example, the changing voltage characteristic on the first scan electrode may be a rising voltage characteristic and at least one of the first and second driving signals is controlled to cause a delay in the initiation of the rising voltage characteristic of the first scan electrode relative to a rising voltage characteristic of the second scan electrode during at least some portion of the at least one of the reset period and the sustain period. Alternatively, the changing voltage characteristic may be a falling voltage characteristic. Also, the changing voltage characteristic may be a rising voltage characteristic followed by a falling voltage characteristic. At least one of the first and second driving signals may be controlled to cause the changing voltage characteristic of the first scan electrode to resemble the changing voltage characteristic of the second scan electrode.

The scan electrodes may be divided in groups. A first group of scan electrodes may include the first scan electrode and the first driving signal is applied to each scan electrode of the first group of scan electrodes. A second group of scan electrodes may include the second scan electrode and the second driving signal is applied to each scan electrode of the second group of scan electrodes. A scan electrode of the first group may be positioned between two scan electrodes of the second group. Some scan electrodes of the first group may be adjacent to each other and some scan electrodes of the second group may be adjacent to each other.

At least one of the first and second driving signals may be controlled to cause a lag in an initiation of a changing voltage characteristic on the first scan electrode during an initial portion of the address period that follows the reset period relative to an initiation of a corresponding changing voltage characteristic on the second scan electrode. The changing voltage characteristic on the first scan electrode during the initial portion of the address period may represent a rising voltage characteristic, and at least one of the first and second driving signals is controlled to cause a lag in the initiation of a rising voltage characteristic of the first scan electrode relative to a rising voltage characteristic of the second scan electrode during the initial portion of the address period

Other features will be apparent from the following description, including the drawings, and the claims.

### BRIEF DESCRIPTION OF THE DRAWINGS

The above and other features will become more apparent with reference to the attached drawings in which:

FIG. 1 illustrates a perspective view of a plasma display panel (PDP) in a typical plasma display device;

FIG. 2 illustrates a plan view of an electrode arrangement of a PDP;

FIG. 3 illustrates a circuit diagram of a scan electrode driving circuit of a typical plasma display device;

FIGS. 4(a) and 4(b) illustrate block diagrams of exemplary connections between scan integrated circuits and delay units in a plasma display device;

FIGS. 5(a) and 5(b) illustrates block diagrams of other exemplary connections between scan integrated circuits and delay units in a plasma display device;

FIGS. 6(a), 6(b) and 6(c) illustrate aspects of a delay unit and its operations;

FIG. 7 illustrates waveforms of first and second control signals and a driving signal that is applied to a scan electrode;

FIG. 8 illustrates other waveforms of first and second control signals and a driving signal that is applied to a scan electrode;

FIG. 9 illustrates a circuit diagram of a circuit for measuring a delayed scan IC voltage;

FIGS. 10(a) and 10(b) present delayed scan IC voltage measurements;

FIG. 11 illustrates an exemplary arrangement of durations of a reset period, an address period, and a sustain period for scan electrodes;

FIG. 12 illustrates another exemplary arrangement of durations of a reset period, an address period and a sustain period for scan electrodes; and

FIG. 13 illustrates a timing diagram of a driving signal for driving a PDP, according to one implementation.

### DETAILED DESCRIPTION

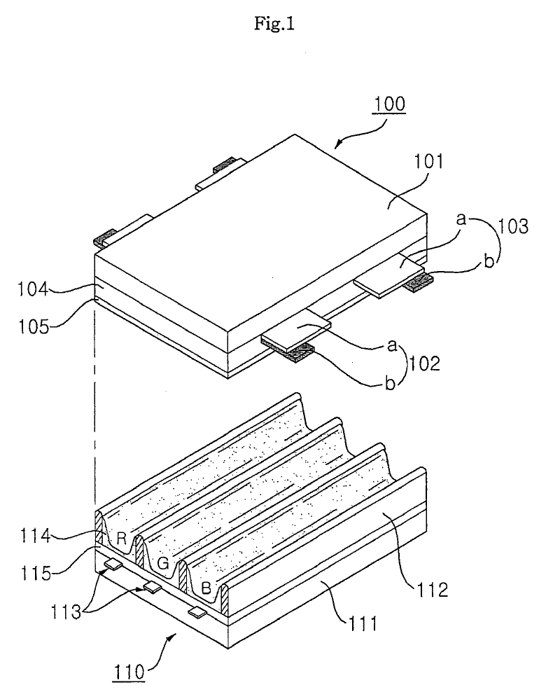

FIG. 1 illustrates a perspective view of a plasma display panel (PDP) in a typical plasma display device. Referring to FIG. 1, the PDP includes an upper panel 100 and a lower panel 110 which are a predetermined distance apart from each other and are coupled in parallel to each other. The upper panel 100 includes an upper substrate 101 which provides a display surface where images are displayed, and electrode pairs which are formed on the upper substrate 101. The electrode pairs include a scan electrode 102 and a sustain electrode 103. The lower panel 110 includes a lower substrate 111 which forms the bottom of the PDP, and address electrodes 113 which are formed on the lower substrate 111 and intersect the electrode pairs formed on the upper substrate 101.

More specifically, the upper panel 100 may include electrode pairs, each electrode pair comprising a scan electrode 102 which includes a transparent electrode 102a and a bus electrode 102b and a sustain electrode 103 which includes a transparent electrode 103a and a bus electrode 103b. The transparent electrodes 102a and 103a may be formed of transparent indium tin oxide (ITO). The scan electrode 102 and the sustain electrode 103 are covered by an upper dielectric layer 104, and a passivation layer 105 is formed on the upper dielectric layer.

The lower panel 110 includes barrier ribs 112 which define discharge cells. The address electrodes 113 are arranged in parallel with the barrier ribs 112. Red (R), green (G), and blue (B) phosphors 114 are deposited on the address electrodes 113. A lower dielectric layer 115 is interposed between the address electrodes 113 and the R, G, and B phosphors 114.

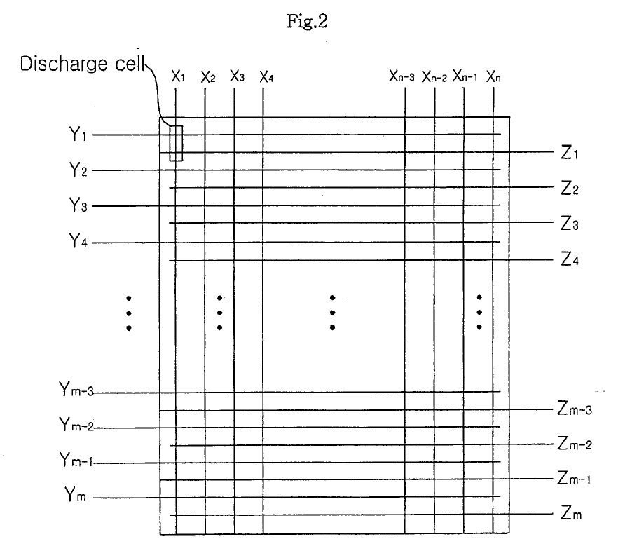

FIG. 2 illustrates an electrode arrangement of a PDP. Referring to FIG. 2, discharge cells may be arranged on a PDP in a matrix form. The discharge cells may be respectively disposed on the intersections between scan electrode lines Y1 through Ym and address electrode lines X1 through Xn, or between sustain electrode lines Z1 through Zm and the address electrode lines X1 through Xn. The scan electrode lines Y1 through Ym may be sequentially driven, the sustain electrode lines Z1 through Zm may be commonly driven, i.e., the same driving signal is applied to the sustain electrode lines Z1 through Zm, and the address electrode lines X1 through Xn may be driven at the same time, i.e., reset, address and sustain periods are initiated at the same time for each address electrode. The electrode arrangement illustrated in FIG. 2 and the driving method thereof are exemplary, and thus, concepts described with reference to them may be applied to various electrode arrangements, other than that illustrated in FIG. 2, and various driving methods, other than that set forth herein. For example, the scan electrode lines Y1 through Ym may be driven using a dual scan method or a double scan method in which two of the scan electrode lines Y1 through Ym are driven at the same time. More specifically, the dual scan method involves dividing a PDP into upper and lower regions and driving a pair of scan electrode lines respectively selected from the upper and lower regions at the same time. The double scan method involves driving a pair of adjacent scan electrode lines at the same time.

Referring to FIG. 2, all the address electrode lines X1 through Xn are driven at the same time. However, an address electrode driving unit may be divided into two parts, one for the odd-numbered address electrode lines and the other for the even-numbered address electrode lines, so the odd-numbered address electrode lines can be driven separately from the even-numbered address electrode lines.

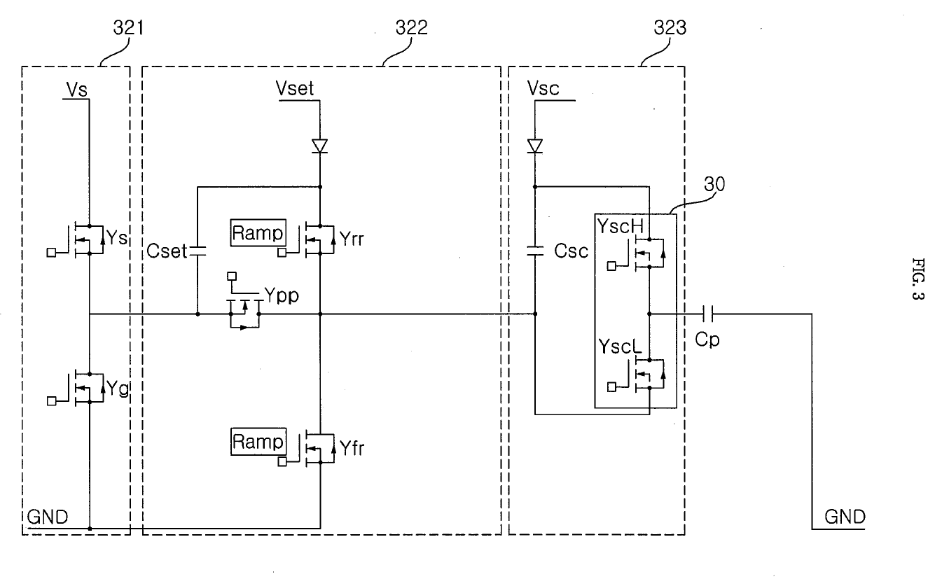

FIG. 3 illustrates a scan electrode driving circuit of a typical plasma display device. Referring to FIG. 3, the scan electrode driving circuit includes a sustain driving unit 321, a reset driving unit 322, and a scan driving unit 323.

The sustain driving unit 321 generates a sustain signal during a sustain period. The sustain driving unit 321 includes a pair of switches Ys and Yg which are connected between a power supply Vs and a ground GND.

The reset driving unit 322 includes a rising ramp switch Yrr which generates a set-up signal whose voltage gradually increases during a reset period, a falling ramp switch Yfr which generates a set-down signal whose voltage gradually decreases during the reset period, a power supply Vset, a capacitor Cset which is driven by a floating power supply, and a switch Ypp.

The scan driving unit 323 generates a scan signal during an address period. The scan driving unit 323 includes a capacitor Csc which stores the voltage of the power supply Vsc, and scan integrated circuits (ICs) 30 which are connected to respective corresponding scan electrodes. The voltage supplied to the scan electrodes is the power supply voltage Vsc. Each of the scan ICs includes a switch YscH which supplies a panel capacitor Cp with a high voltage and a switch YscL which supplies the panel capacitor Cp with a low voltage.

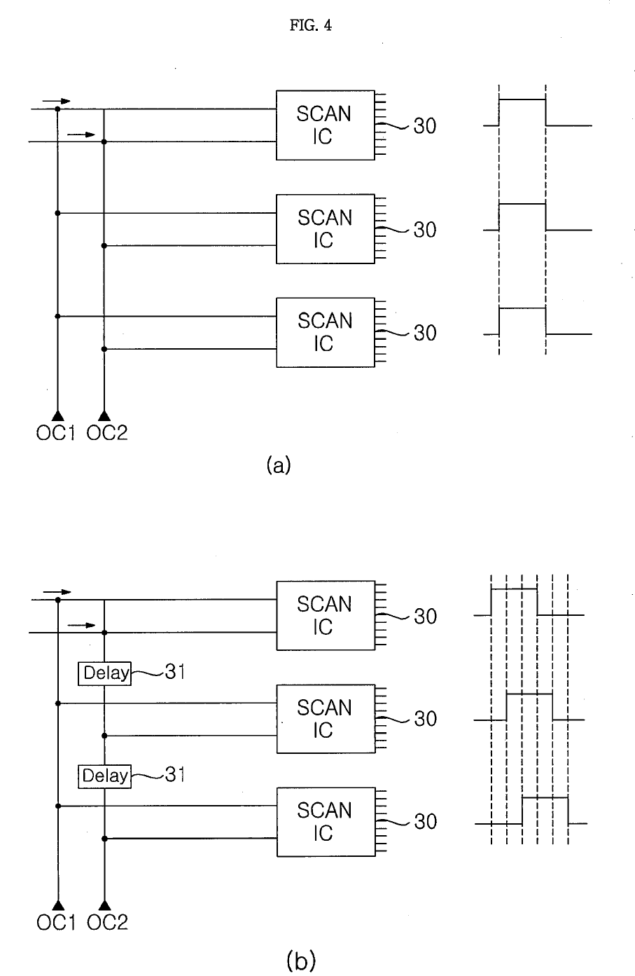

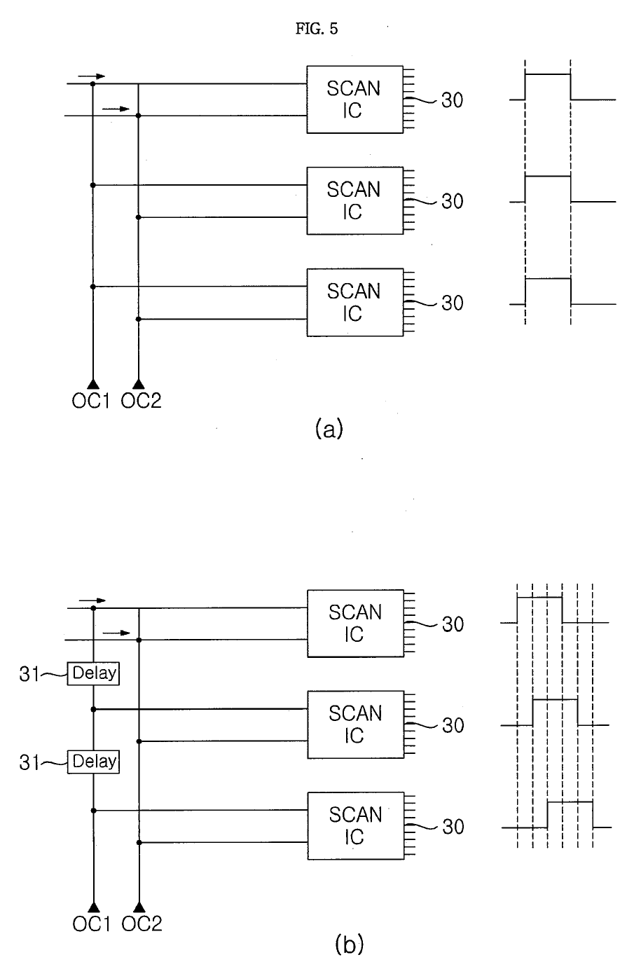

FIGS. 4(a) and 4(b) illustrate block diagrams for explaining exemplary connections between scan ICs 30 and delay units 31, and FIGS. 5(a) and 5(b) illustrate block diagrams for explaining other exemplary connections between the scan ICs 30 and the delay units 31.

Referring to FIGS. 4(a), 4(b), 5(a) and 5(b), a plasma display device may include scan ICs 30 which apply a driving signal to corresponding scan electrodes in response to input control signals and delay units 31 which delay the input control signal and output the delayed control signal to the scan ICs 30 so that the scan ICs 30 can delay the driving signal. Examples of the input control signal for controlling the scan ICs 30 include a first control signal OC1 and a second control signal OC2. FIGS. 4(a) and 4(b) illustrate how to connect the delay units 31 to the scan ICs 30 to delay the second control signal OC2, and FIGS. 5(a) and 5(b) illustrate how to connect the delay units 31 to the scan ICs 30 to delay the first control signal OC1. Waveform measurements obtained using the connection structure illustrated in FIGS. 4(a) and 4(b) and the connection structure illustrated in FIGS. 5(a) and 5(b) indicate that the same signal delay effect can be obtained regardless of whether the delay units 31 are connected to the scan ICs 30 to delay the first or second control signal OC1 or OC2.

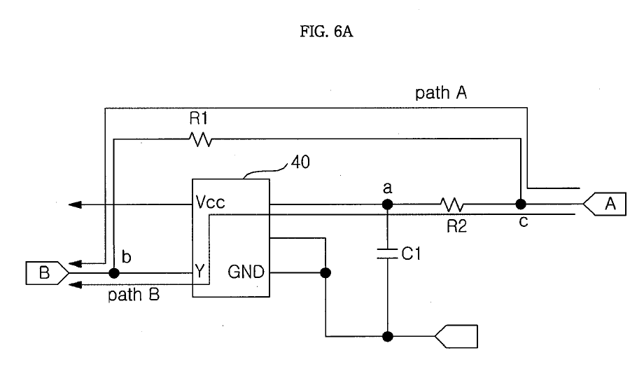

FIGS. 6(a), 6(b) and 6(c) illustrate aspects of a delay unit and its operations. Referring to FIG. 6(a), the delay unit includes two paths, i.e., path A and path B. An input control signal may be output to a scan IC, which is connected to the delay unit, by taking either path A or path B. More specifically, the input control signal may be output to the scan IC along path A by passing through node c, a resistor R1, and node b. The input control signal may be output to the scan IC along path B by passing through node c and a resistor R2, being delayed at a buffer 40, and passing through node b. The delay unit may delay the input control signal for the scan IC by enabling the input control signal to selectively take path A or path B at node c.

FIG. 6(b) illustrates a circuit diagram of path B illustrated in FIG. 6(a). Referring to FIG. 6(b), an input control signal, which is input through node c, arrives at node a by passing through the resistor R2. Because of the RC connection including R2 and C1, the voltage at node a increases by following a rising curve. Accordingly, a delayed signal is output from the buffer 40.

FIG. 6(c) illustrates voltage waveforms at nodes, c, a, and b illustrated in FIG. 6(b). Referring to FIG. 6(c), the delay unit can delay an input control signal because of the RC connection including R2 and C1. The amount of delayed time (hereinafter referred to as a delay time Td) may be determined by the impedances of the resistor R2 and the capacitor C1. In other words, the delay time Td may be determined by a time constant τ. The time constant τ may be represented by the following equation: τ=R2*C1.

As described above, the delay unit can delay a control signal for a scan IC connected thereto by using path B. The delay unit may be connected to more than one scan ICs. In this case, the delay unit may transmit a delayed control signal obtained using path B to the scan ICs connected thereto so that the scan ICs can be delayed at the same time.

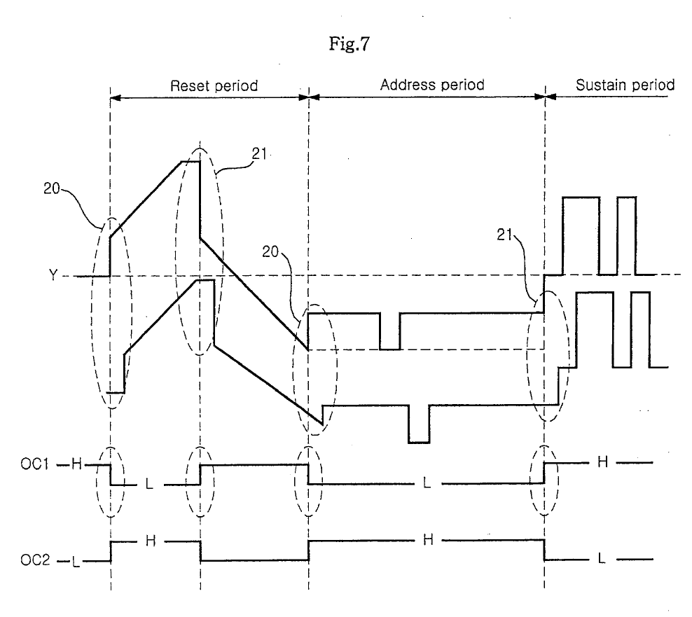

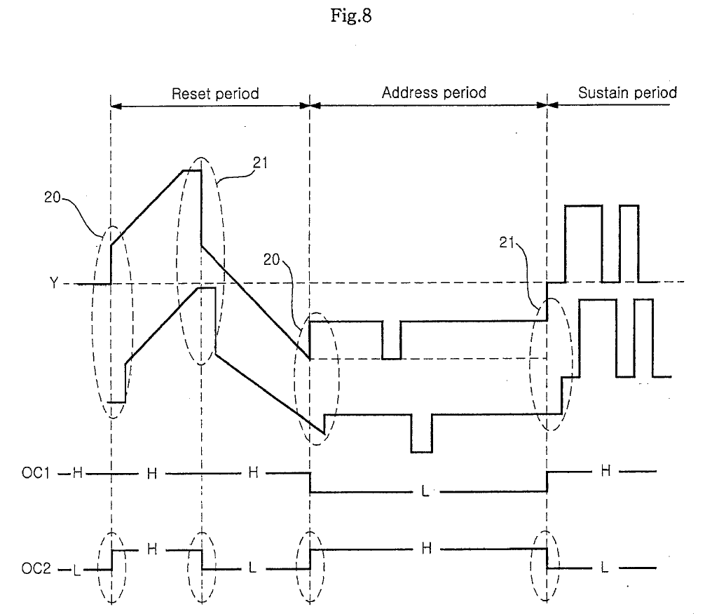

FIG. 7 explains an exemplary relationship between first and second control signals OC1 and OC2 and a driving signal that is applied to a scan electrode, and FIG. 8 explains another exemplary relationship between the first and second control signals OC1 and OC2 and a driving signal that is applied to a scan electrode.

Referring to FIGS. 7 and 8, one or more driving signals may be applied to a scan electrode Y during a reset period, an address period, and a sustain period. More specifically, one or more driving signals may be applied to the scan electrode Y via a scan IC. The scan IC may be driven in response to the first and second control signals OC1 and OC2. A scan voltage Vsc, which is an example of the driving signals, may be applied to the scan electrode Y during a set-up period, which is part of the reset period, or during the address period. It may be determined whether to apply the scan voltage Vsc to the scan electrode Y according to the logic levels of the first and second control signals OC1 and OC2, and this is as follows:
1. When the first and second control signals OC1 and OC2 are both logic low, the switch of the scan IC is floated;
2. When the first and second control signals OC1 and OC2 are both logic high, the scan IC applies the scan voltage Vsc to the scan electrode Y;
3. When the first control signal OC1 is logic high and the second control signal is logic low, the scan IC removes the scan voltage Vsc; and
4. When the first control signal OC1 is logic low and the second control signal OC2 is logic high, the scan IC applies the scan voltage Vsc and then removes the scan voltage Vsc when a voltage is applied to an address electrode.

In short, the scan voltage Vsc may be applied to the scan electrode Y when the first and second control signals OC1 and OC2 are both logic high (or when the first control signal OC1 is logic low and the second control signal OC2 is concurrently logic high). If at least one of the first and second control signals OC1 and OC2 changes from a logic low level to a logic high level or vice versa before or during the application of the scan voltage Vsc to the scan electrode Y, then whichever of the first and second control signals OC1 and OC2 changes from the logic low level to the logic high level or vice versa may be delayed. More specifically, the first or second control signal OC1 or OC2 may be delayed at the beginning of the reset period, the address period, or the sustain period or at the end of the reset period or the address period. In addition, if the reset period is divided into the set-up period when the voltage of the scan electrode Y gradually increases and a set-down period when the voltage of the scan electrode Y gradually decreases, the first or second control signal OC1 or OC2 may be delayed at the beginning of the set-up period or the set-down period or at the end of the set-up period or the set-down period.

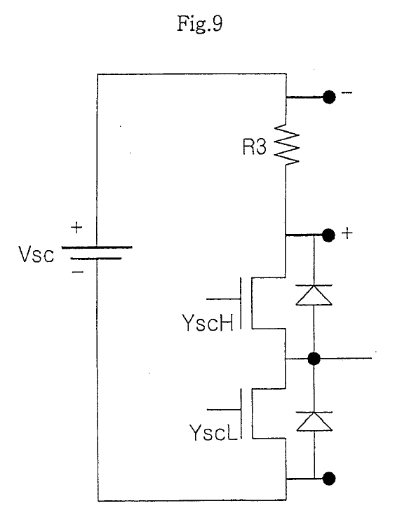

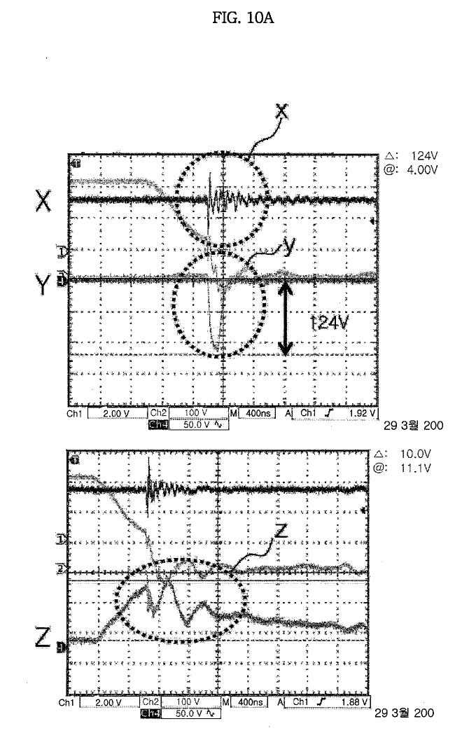

FIG. 9 illustrates a circuit diagram of a circuit for measuring a delayed scan IC voltage, and FIGS. 10(a) and 10(b) present delayed scan IC voltage measurements. More specifically, FIG. 9 illustrates a circuit diagram of a scan IC for testing the effect of delaying a control signal, and FIGS. 10(a) and (b) illustrate graphs for presenting scan IC voltage measurements using the scan IC illustrated in FIG. 9.

Referring to FIGS. 9, 10(a) and 10(b), a voltage drop Y between both ends of a resistor R3 is caused by a current that flows into the scan IC. A reduction in the voltage drop Y may be interpreted as a reduction in the current that flows into the scan IC. FIG. 10(a) presents conventional scan IC voltage measurements, and FIG. 10(b) presents exemplary scan IC voltage measurements obtained when exploring some of the concepts described herein. Referring to FIGS. 10(a) and 10(b), a voltage drop (Y) of 100 V is realized, which is lower than conventionally observed, i.e., a voltage drop (Y) of 124 V. In addition, the scan IC voltage measurements illustrated in FIGS. 10(a) and 10(b) indicate that considerable reductions in peaking noise Z in the scan voltage may be achieved.

The relationship between the delay time Td and the voltage drop Y will hereinafter be described in detail with reference to Table 1 below.

TABLE 1

| | |
|---|---|
| Delay Time (Td) | Voltage Drop (Y) |

| | | | |
|---|---|---|---|
| 0 | us | 124 | V |
| 10 | ns | 122 | V |
| 20 | ns | 121 | V |
| 30 | ns | 100 | V |
| 40 | ns | 98 | V |
| 50 | ns | 97 | V |
| 100 | ns | 94 | V |
| 200 | ns | 95 | V |
| 500 | ns | 99 | V |

Referring to Table 1, when the delay time Td is within the range of 30 ns to 500 ns, the voltage drop Y can be reduced/minimized. Therefore, in at least one implementation, it may be useful to establish a delay time Td within the range of 30 ns to 500 ns.

Various methods of driving a PDP can be realized by properly delaying driving signals.

For example, a PDP may be driven by setting the length of at least one of a reset period, an address period, and a sustain period so that driving signals respectively applied to at least two scan electrodes can differ from each other in terms of the length of at least one of the reset period, the address period, and the sustain period. Driving signals applied to scan electrodes may be controlled such that an initiation of a changing voltage characteristic on one scan electrode during at least one of the reset period and the sustain period lags an initiation of a corresponding changing voltage characteristic on another scan electrode. Then, at one point in time in one of the reset period and the sustain period, the voltages on the two scan electrodes may differ relative to each other.

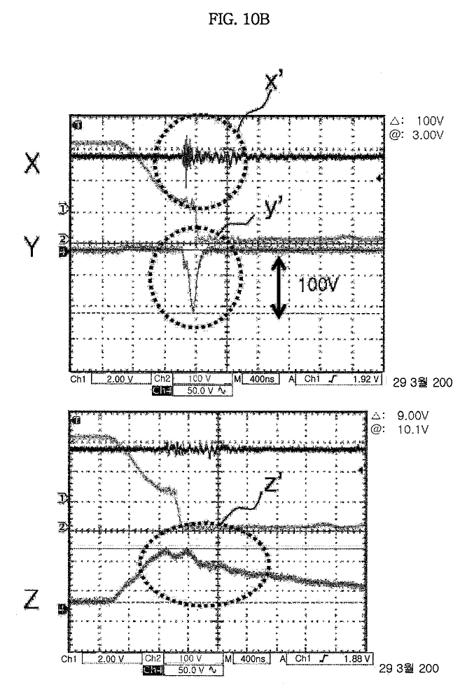

FIG. 11 illustrates an exemplary arrangement of durations of a reset period, an address period, and a sustain period for scan electrodes. Referring to FIG. 11, a reset period for a scan electrode Y2 is longer than a reset period for a scan electrode Y1, an address period for a scan electrode Y3 is longer than an address period for the scan electrode Y1, and a sustain period for a scan electrode Y4 is longer than a sustain period for the scan electrode Y1. These settings of the durations of the reset period, the address period, and the sustain period for each scan electrode may be performed using scan ICs and delay units of a plasma display device.

A method of driving a PDP can set the length of at least one of a reset period, an address period, and a sustain period so that driving signals respectively applied to at least two scan electrodes can differ from each other in terms of the length of at least one of the reset period, the address period, and the sustain period. The length of one of the reset period, the address period, and the sustain period may be altered by delaying the beginning of one of the reset period, the address period, and the reset period or delaying the end of one of the reset period, the address period, and the reset period.

When the beginning or the end of one of a reset period, an address period, and a reset period is delayed, a potential difference is likely to be generated between scan electrodes.

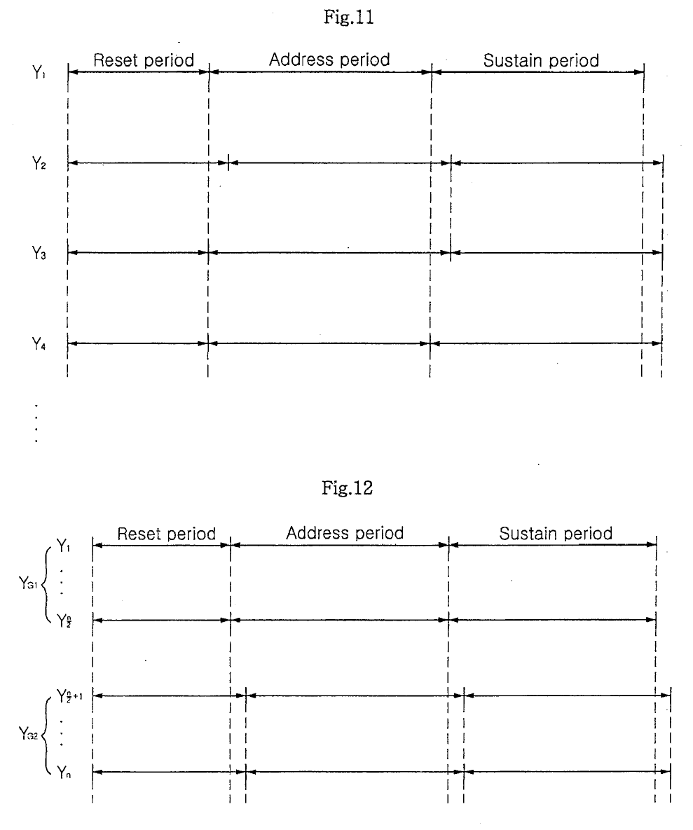

FIG. 12 illustrates another exemplary arrangement of the durations of a reset period, an address period, and a sustain period for scan electrodes.

Referring to FIG. 12, scan electrodes are divided into two groups, i.e., a first scan electrode group including upper scan electrodes and a second scan electrode group including lower scan electrodes. Then, the length of a reset period may be set so that a driving signal applied to a scan electrode belonging to the first scan electrode group differs from a driving signal applied to a scan electrode belonging to the second scan electrode group in terms of the length of the reset period. Referring to FIG. 12, the durations of a reset period is different between the first and second scan electrode groups. Other exemplary arrangements of the durations of a reset period, an address period, and a sustain period for scan electrodes may be applicable. Also, referring to FIG. 12, scan electrodes are divided into one group including upper scan electrodes and another group including lower scan electrodes. However, other groupings are also possible. For example, the scan electrodes may be divided into one group including odd-numbered scan electrodes and another group including even-numbered scan electrodes. Alternatively, the scan electrodes may be divided into more than two groups. Still alternatively, the scan electrodes may be divided into as many groups as there are scan ICs according to the connections between the scan electrodes and the scan ICs. The durations of a reset period, an address period, and a sustain period may be uniform throughout scan electrodes belonging to the same group.

The length of one of a reset period, an address period, and a sustain period may be altered by delaying the beginning or the end of one of the reset period, the address period, and the sustain period by, for example, 30 ns-500 ns.

When the beginning or the end of one of a reset period, an address period, and a sustain period is delayed, a potential difference is likely to be generated between scan electrodes belonging to different groups.

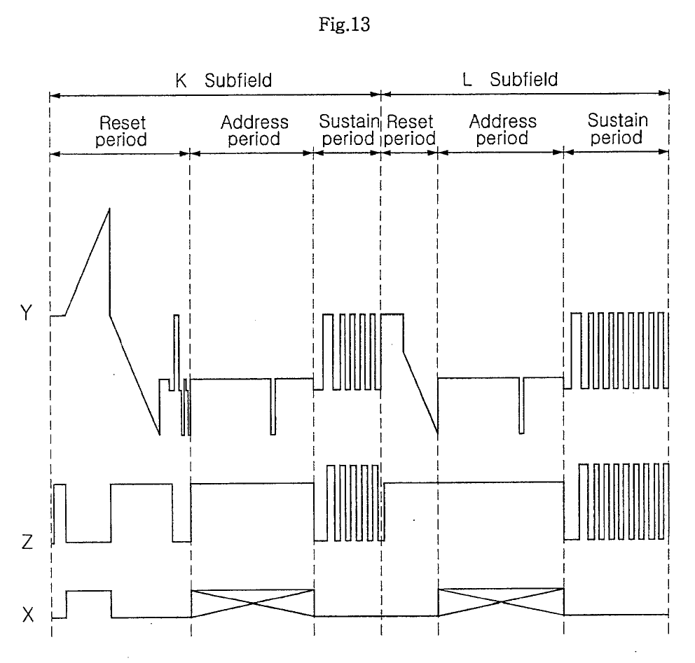

An example of a driving signal for driving a PDP according to one implementation will hereinafter be described in detail with reference to FIG. 13.

FIG. 13 illustrates a timing diagram of a driving signal for driving a PDP. Referring to FIG. 13, each of sub-fields includes a reset period, an address period, and a sustain period. In FIG. 13, the signal applied to the scan electrode is represented by Y, the signal applied to the sustain electrode is represented by Z, and the signal applied to the address electrode is represented by X.

During the reset period of a K-th sub-field, which is one of the sub-fields, a set-up signal whose voltage gradually increases and a set-down signal whose voltage gradually decreases are applied to each scan electrode. A period during which the set-up signal is applied and a period during which the set-down signal is applied are referred to as a set-up period and a set-down period, respectively. During the set-up period, a positive voltage is applied to each address electrode. During the set-up period, a set-up discharge occurs in all discharge cells so that wall charges can accumulate. During the set-down period, the set-down signal is applied, thereby causing a mild erase discharge. As a result of the mild erase discharge, sufficient wall charges to stably cause an address discharge uniformly remain in the discharge cells.

During the address period of the K-th sub-field, a scan signal is applied to each scan electrode, and a positive data signal that is synchronized with the scan signal is applied to the address electrodes of selected discharge cells. Due to the difference between the scan signal and the data signal in addition to a wall voltage generated during the reset period of the K-th sub-field, an address discharge occurs in the discharge cells, and thus, wall charges for causing a sustain discharge are generated.

During a predetermined sub-field, for example, the K-th sub-field, a positive voltage and a negative voltage may be sequentially applied to each scan electrode, before the application of a scan pulse to each scan electrode, in order to stabilize a discharge. More specifically, an address discharge can be stably performed by applying a stabilization signal vibrating between a positive voltage and a negative voltage to each scan electrode so that a sufficient wall charge state to stably cause an address discharge can be established in each discharge cell. The stabilization signal may have a positive voltage only. The stabilization signal may have a rectangular waveform, as illustrated in FIG. 13, or may have a gradually ascending or descending ramp waveform. The stabilization signal may be applied during a sub-field with a relatively low grayscale weight, for example, at least one of first through fourth sub-fields, which have relatively short sustain periods. The positive voltage of the stabilization signal may be the same as a sustain voltage applied during a sustain period, and the negative voltage of the stabilization signal may be the same as a scan voltage applied during an address period.

During the sustain period of the K-th sub-field, sustain signals are applied to a scan electrode and a sustain electrode. A sustain discharge, i.e., a display discharge, occurs in one or more discharge cells that are selected by an address discharge, when the sustain signals are applied. The sustain signals may be applied in a manner other than that illustrated in FIG. 13. For example, a sustain signal vibrating between a positive sustain voltage and a negative sustain voltage may be applied to one of a scan electrode and a sustain electrode and the ground voltage is applied to the other electrode. Alternatively, a positive voltage (+)Vs/2 (where Vs indicates a sustain voltage) may be applied to a scan electrode and a negative voltage (−)Vs/2 may be applied to a sustain electrode. Still alternatively, the negative voltage (−)Vs/2 may be applied to a scan electrode and the positive voltage (+)Vs/2 may be applied to a sustain electrode.

An L-th sub-field, another sub-field, includes a reset period, an address period, and a sustain period. During the L-th sub-field, driving signals may be applied to each electrode in almost the same manner as they are during the K-th sub-field.

During the reset period of the L-th sub-field, unlike during the reset period of the K-th sub-field, neither a gradually rising signal is applied as a set-up signal nor a vibrating signal is applied after the application of a set-down signal, in order to secure sufficient timing margin to properly drive a PDP. Such signals may be optional depending, for example, on the duration of a sub-field.

FIG. 13 illustrates only one scan electrode Y. However, another driving signal may be applied to another scan electrode. As illustrated in FIG. 11, the duration of at least one of the reset period, the address period, and the sustain period of one driving signal may be different from that of the other driving signal. For example, the duration of at least one of the set-up period and the set-down period of one driving signal is different from than of the other driving signal. In such a case, a difference in voltage level is likely to be generated between scan electrodes at a certain moment.

In the arrangement as described above, it is possible to reduce peaking noise, which is likely to be generated when a scan voltage is applied, by delaying a driving signal (particularly, a scan voltage) applied to scan electrodes using scan ICs and delay units. Also, the peaking noise may cause scan ICs to break down internally, thereby considerably deteriorating product reliability. The above arrangement of delaying driving signals, therefore, may enhance the reliability of driving scan ICs by reducing the possibility of breakdown of scan ICs.

Other implementations are within the scope of the following claims.

What is claimed is:

1. A method of driving a plasma display panel (PDP), comprising:
applying a first driving signal to a first scan electrode to effect at least one of a reset period and a sustain period,
applying a second driving signal to a second scan electrode to effect at least one of a reset period and a sustain period, and
controlling at least one of the first and second driving signals to cause a lag in an initiation of a changing voltage characteristic on the first scan electrode during at least one of the reset period and the sustain period relative to an initiation of a corresponding changing voltage characteristic on the second scan electrode.

2. The method of claim 1, wherein the changing voltage characteristic on the first scan electrode is a rising voltage characteristic, and wherein at least one of the first and second driving signals is controlled to cause a delay in the initiation of a rising voltage characteristic of the first scan electrode relative to a rising voltage characteristic of the second scan electrode during at least some portion of the at least one of the reset period and the sustain period.

3. The method of claim 2, wherein at least one of the first and second driving signals is controlled to cause the rising voltage characteristic of the first scan electrode to resemble the rising voltage characteristic of the second scan electrode.

4. The method of claim 1, wherein the changing voltage characteristic on the first scan electrode is a falling voltage characteristic, and wherein at least one of the first and second driving signals is controlled to cause a delay in the initiation of a falling voltage characteristic of the first scan electrode relative to a falling voltage characteristic of the second scan electrode during at least some portion of the at least one of the reset period and the sustain period.

5. The method of claim 1, wherein a period during which the changing voltage characteristic of the first scan electrode lags the changing voltage characteristic of the second scan electrode is longer for the first scan electrode than for the second scan electrode.

6. The method of claim 1, wherein the changing voltage characteristic on the first scan electrode is a rising voltage characteristic followed by a falling voltage characteristic, and wherein at least one of the first and second driving signals is controlled to cause a delay in the initiation of a rising voltage characteristic followed by a falling voltage characteristic on the first scan electrode relative to a rising voltage characteristic followed by a falling voltage characteristic of the second scan electrode during at least some portion of the at least one of the reset period and the sustain period.

7. The method of claim 1, wherein a first group of scan electrodes includes the first scan electrode and the first driving signal is applied to each scan electrode of the first group of scan electrodes, and wherein a second group of scan electrodes includes the second scan electrode and the second driving signal is applied to each scan electrode of the second group of scan electrodes.

8. The method of claim 1, further comprising controlling at least one of the first and second driving signals to cause a lag in an initiation of a changing voltage characteristic on the first scan electrode during an initial portion of an address period that follows the reset period relative to an initiation of a corresponding changing voltage characteristic on the second scan electrode.

9. The method of claim 8, wherein the changing voltage characteristic on the first scan electrode during the initial portion of the address period represents a rising voltage characteristic, and wherein at least one of the first and second driving signals is controlled to cause a lag in the initiation of a rising voltage characteristic of the first scan electrode relative to a rising voltage characteristic of the second scan electrode during the initial portion of the address period.

10. The method of claim 1, wherein at least one of the first and second driving signals is controlled to cause the lag in the initiation of the changing voltage characteristic of the first scan electrode relative to the initiation of the changing voltage characteristic of the second scan electrode during the reset period.

11. The method of claim 1, wherein at least one of the first and second driving signals is controlled to cause the lag in the initiation of the changing voltage characteristic of the first scan electrode relative to the initiation of the changing voltage characteristic of the second scan electrode during the sustain period.

12. A method of driving a plasma display panel (PDP), comprising:
applying a first driving signal to a first scan electrode to effect at least one of a reset period and a sustain period,
applying a second driving signal to a second scan electrode to effect at least one of a reset period and a sustain period, and
controlling at least one of the first and second driving signals to cause a difference, at one point in time during at least one of the reset period and the sustain period, between a voltage at the first scan electrode and a voltage at the second scan electrode.

13. A plasma display panel (PDP), comprising:
an upper substrate;
a lower substrate opposite to the upper substrate;
a plurality of scan electrodes positioned between the upper and lower substrates, the plurality of scan electrodes including first and second scan electrodes;
a plurality of address electrodes positioned between the upper and lower substrates;
a plurality of sustain electrodes positioned between the upper and lower substrates; and
a control circuit configured to apply a first driving signal to the first scan electrode to effect at least one of a reset period and a sustain period, to apply a second driving signal to the second scan electrode to effect at least one of a reset period and a sustain period, and to control the first and second driving signals to cause a lag in a changing voltage characteristic on the first scan electrode during at least one of the reset period and the sustain period relative to a corresponding changing voltage characteristic on the second scan electrode.

14. The plasma display panel of claim 13, wherein the changing voltage characteristic on the first scan electrode is a rising voltage characteristic, and wherein the control circuit is configured to control the first and second control signals to cause a delay in an initiation of a rising voltage characteristic of the first scan electrode relative to a rising voltage characteristic of the second scan electrode during at least some portion of the at least one of the reset period and the sustain period.

15. The plasma display panel of claim 14, wherein the control circuit is configured to control the first and second driving signals to cause the rising voltage characteristic of the first scan electrode to resemble the rising voltage characteristic of the second scan electrode.

16. The plasma display panel of claim 13, wherein the changing voltage characteristic on the first scan electrode is a falling voltage characteristic, and wherein the control circuit is configured to control the first and second control signals to cause a delay in an initiation of a falling voltage characteristic of the first scan electrode relative to a falling voltage characteristic of the second scan electrode during at least some portion of the at least one of the reset period and the sustain period.

17. The plasma display panel of claim 13, wherein the control circuit is configured to control the first and second driving signals such that a period during which the changing voltage characteristic of the first scan electrode lags the changing voltage characteristic of the second scan electrode is longer for the first scan electrode than for the second scan electrode.

18. The plasma display panel of claim 13, wherein the changing voltage characteristic on the first scan electrode is a rising voltage characteristic followed by a falling voltage characteristic, and wherein the control circuit is configured to control the first and second driving signals to cause a delay in an initiation of a rising voltage characteristic followed by a falling voltage characteristic on the first scan electrode relative to a rising voltage characteristic followed by a falling voltage characteristic of the second scan electrode during at least some portion of the at least one of the reset period and the sustain period.

19. The plasma display panel of claim 13, wherein a first group of scan electrodes includes the first scan electrode and the control circuit is configured to apply the first driving signal to each scan electrode of the first group of scan electrodes, and wherein a second group of scan electrodes includes the second scan electrode and the control circuit is configured to apply the second driving signal to each scan electrode of the second group of scan electrodes.

20. The plasma display panel of claim 13, wherein the control circuit is configured to control the first and second driving signals to cause a lag in an initiation of a changing voltage characteristic on the first scan electrode during an initial portion of an address period that follows the reset period relative to an initiation of a corresponding changing voltage characteristic on the second scan electrode.

21. The plasma display panel of claim 20, wherein the changing voltage characteristic on the first scan electrode during the initial portion of the address period represents a rising voltage characteristic, and wherein the control circuit is configured to control the first and second driving signals to cause a lag in the initiation of a rising voltage characteristic of the first scan electrode relative to a rising voltage characteristic of the second scan electrode during the initial portion of the address period.

22. The plasma display panel of claim 13, wherein the control circuit is configured to control the first and second driving signals to cause the lag in the initiation of the changing voltage characteristic of the first scan electrode relative to the initiation of the changing voltage characteristic of the second scan electrode during the reset period.

23. The plasma display panel of claim 13, wherein the control circuit is configured to control the first and second driving signals to cause the lag in the initiation of the changing voltage characteristic of the first scan electrode relative to the initiation of the changing voltage characteristic of the second scan electrode during the sustain period.
